(19) United States
(12) Patent Application Publication
(10) Pub. No.: US 2026/0262619 A1
(43) Pub. Date: Sep. 10, 2026

(54) Fishing Rod with Adjustable Action

(71) Applicant: Heath Perry, Parrish, FL (US)

(72) Inventor: Heath Perry, Parrish, FL (US)

(21) Appl. No.: 19/552,298

(22) Filed: Feb. 27, 2026

Related U.S. Application Data
(60) Provisional application No. 63/768,903, filed on Mar. 8, 2025.

(51) Int. Cl. A01K 87/02; A01K 87/04; A01K 87/08

(52) U.S. Cl. CPC A01K 87/02; A01K 87/04; A01K 87/08

(57) ABSTRACT

A fishing rod with adjustable action includes a handle portion and a plurality of laminar carbon fiber elements extending longitudinally from the handle portion. Each laminar carbon fiber element comprises a flat carbon fiber member. A tip top guide is configured to selectively engage with one or more of the plurality of laminar carbon fiber elements. The action of the fishing rod is adjustable based on the number of laminar carbon fiber elements engaged with the tip top guide. The fishing rod provides multiple distinct action characteristics using a single rod, allowing anglers to adapt to different fishing conditions, techniques, or target species without changing equipment.

### FIELD

The present invention relates generally to fishing equipment, and more particularly to fishing rods with adjustable action characteristics.

### BACKGROUND

Fishing rods typically comprise an elongated blank that extends from a handle portion to a tip portion. The blank is typically manufactured with predetermined action characteristics, which determine how the rod flexes or bends when subjected to a load, such as during casting or when fighting a fish. The action of a fishing rod is typically described in terms such as "fast," "medium," or "slow," referring to where along the blank the rod primarily flexes and how quickly it returns to its original position.

Conventional fishing rods are manufactured with a specific, predetermined action that cannot be modified by the user. This limitation often requires anglers to purchase and carry multiple fishing rods with different action characteristics to accommodate various fishing techniques, target species, or environmental conditions. This represents a significant cost and inconvenience to the angler.

Attempts have been made to create adjustable fishing rods. For example, some designs incorporate telescoping sections or interchangeable tip sections. But these designs often suffer from structural weaknesses at connection points, added weight, or limited adjustability. Other approaches involve mechanical components that add complexity, weight, and potential failure points to the rod.

Carbon fiber has become a popular material for manufacturing fishing rod blanks due to its excellent strength-to-weight ratio and flexibility characteristics. Traditional carbon fiber fishing rod blanks are typically constructed as tubular structures with tapered designs to create specific action characteristics. However, once manufactured, these characteristics remain fixed.

Therefore, there exists a need for an improved fishing rod design that provides adjustable action characteristics while maintaining structural integrity, without significantly increasing weight or complexity.

### SUMMARY

The fishing rod with adjustable action addresses these limitations by providing a fishing rod with adjustable action, allowing anglers to modify the rod's flexibility characteristics according to specific fishing requirements without changing equipment.

The invention provides a fishing rod comprising a handle portion and a plurality of laminar carbon fiber elements extending longitudinally from the handle portion. Each laminar carbon fiber element comprises a flat carbon fiber member. A tip top guide is configured to selectively engage with one or more of the plurality of laminar carbon fiber elements. The flexibility or action of the fishing rod is adjustable based on the number of laminar carbon fiber elements engaged with the tip top guide.

In some embodiments, the fishing rod comprises four laminar carbon fiber elements, allowing for four distinct action configurations. By engaging the tip top guide with one, two, three, or four laminar carbon fiber elements, the angler can select from very flexible, or slow action to progressively stiffer, or medium to fast action. The thickness of each laminar carbon fiber element may range from approximately 0.5 mm to 2.0 mm, depending on the desired overall stiffness of the fishing rod.

While carbon fiber is the preferred material, other flexible resilient materials may also be used. For example, in lower cost versions certain types of plastic such as HDPE may be used. Additional materials include fiberglass and spring steel.

The fishing rod with adjustable action also provides a method of adjusting the action of a fishing rod by selecting a desired action characteristic by engaging a tip top guide with a selected number of laminar carbon fiber elements based on the desired action characteristic. Engaging the tip top guide with a greater number of laminar carbon fiber elements results in decreased flexibility, or faster action, of the fishing rod.

This fishing rod with adjustable action offers further advantages over conventional fishing rods. Anglers can adjust rod action based on specific fishing conditions, techniques, or target species without carrying multiple rods. The design maintains structural integrity while providing adjustability, and the carbon fiber laminar elements keep the overall weight comparable to conventional rods.

In operation, an angler can adjust the action of the fishing rod by following these steps:
1. Determine the desired action characteristic based on fishing conditions, techniques, or target species.
2. Loosen the fastener on the attachment mechanism of the tip top guide.
3. Select the appropriate number of laminar carbon fiber elements to engage based on the desired action.
4. Position the selected laminar carbon fiber elements within the channels or grooves of the base plate.
5. Engage the fastener to secure the tip top guide to the selected laminar carbon fiber elements.

The present invention provides several advantages over conventional fishing rods. The adjustable action allows anglers to effectively use a single rod for multiple fishing techniques or target species. The design maintains structural integrity while providing adjustability, and the use of carbon fiber laminar elements keeps the overall weight comparable to conventional rods.

Additionally, the laminar construction provides unique performance characteristics not typically found in conventional tubular rod blanks. The flat profile of the laminar carbon fiber elements 18 creates different flexural properties in different planes, which can enhance casting accuracy and sensitivity.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a first view of the fishing rod with adjustable action.

FIG. 2 illustrates a second view of the fishing rod with adjustable action.

FIG. 3 illustrates a third view of the fishing rod with adjustable action.

FIG. 4 illustrates a first view of the tip of the fishing rod with adjustable action.

FIG. 5 illustrates a second view of the tip of the fishing rod with adjustable action.

FIG. 6 illustrates a detail view of the tip top guide of the fishing rod with adjustable action.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

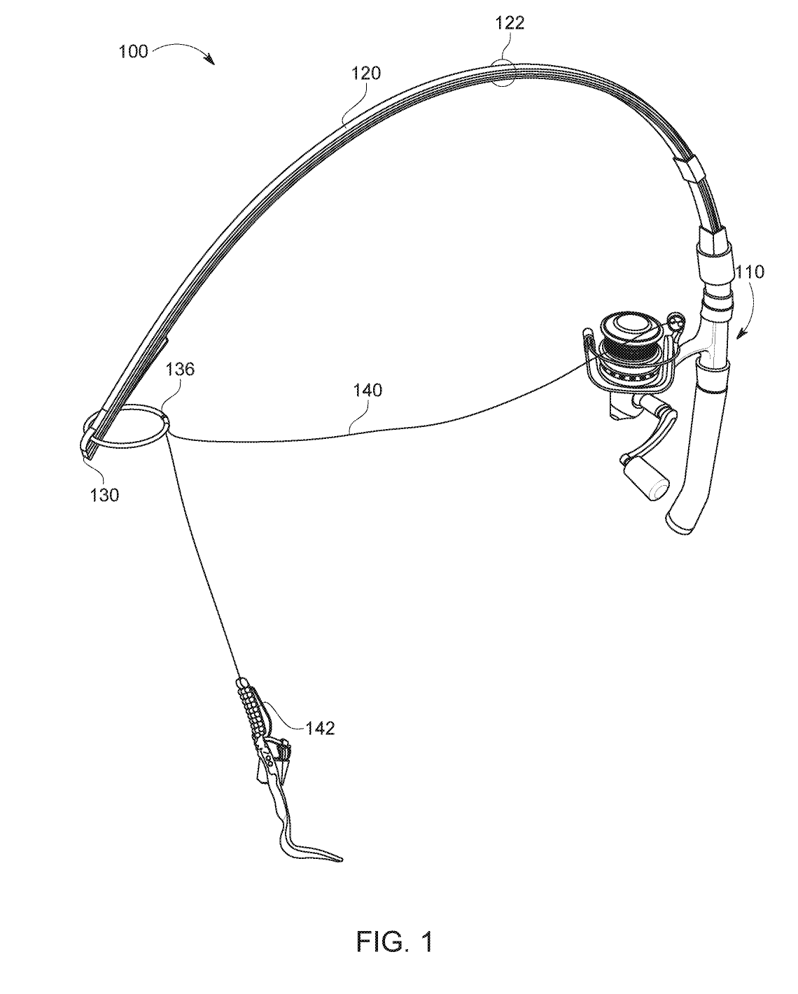

Referring to FIG. 1, a first view of the fishing rod with adjustable action is shown.

The fishing rod with adjustable action 100 is shown with handle 110 grip 112 connected to the blank 120.

The blank 120 is formed from multiple planar elements 122. In some embodiments, the planar elements 122 are rectangular in cross section (planar), presenting a flat profile allowing them to stack and bend together without sliding sideways under load.

Also shown is the tip 130 with ring 136. The fishing line 140 runs from the reel 116, through the ring 136 and to the lure 142. In some embodiments, the ring 136 of the tip top guide 132 is large enough for the lure 142 to pass through it.

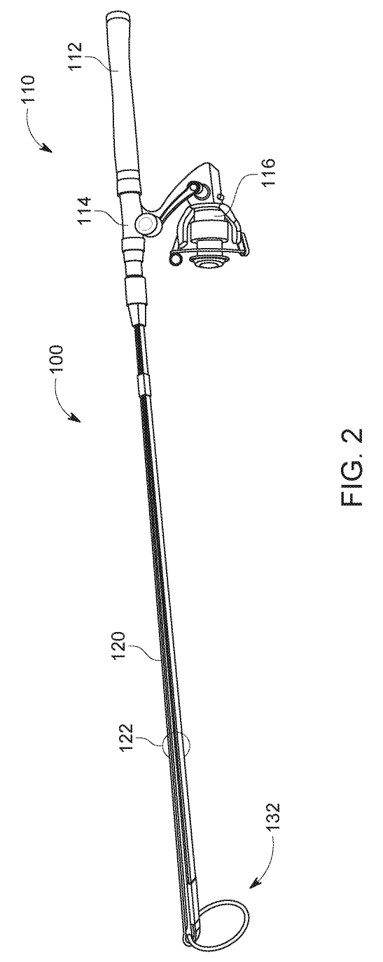

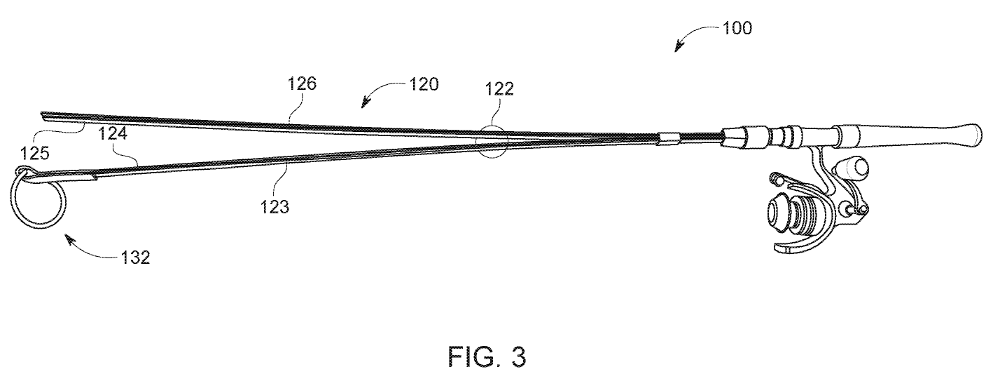

Referring to FIGS. 2 and 3, a second and third view of the fishing rod with adjustable action are shown.

The separability of the blank 120 is shown into multiple planar elements 122, specifically first planar element 123, second planar element 124, third planar element 125 and fourth planar element 126.

The stiffness of the blank 120 is adjusted by varying the number of planar elements 122 connected to the tip top guide 132. As in FIG. 3, two planar elements 123/124 are connected to the tip and the remaining two planar elements 125/126 are not connected, defining a certain stiffness or action, as opposed to, for example, connecting all four planar elements 123/124/125/126 which would provide a higher degree of stiffness and a tighter action.

The handle 110 is shown with grip 112 and reel 116 affixed via reel seat 114.

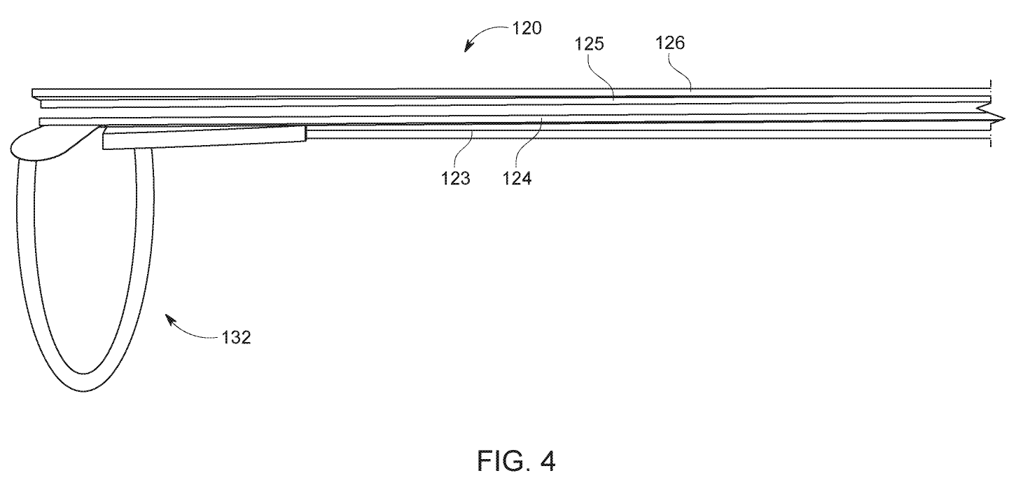

Referring to FIG. 4, a first view of the tip of the fishing rod with adjustable action is shown.

In this figure, the tip top guide 132 is affixed to the first planar element 123 and the second planar element 124 of the planar elements 122 of the blank 120. The result is a medium stiffness.

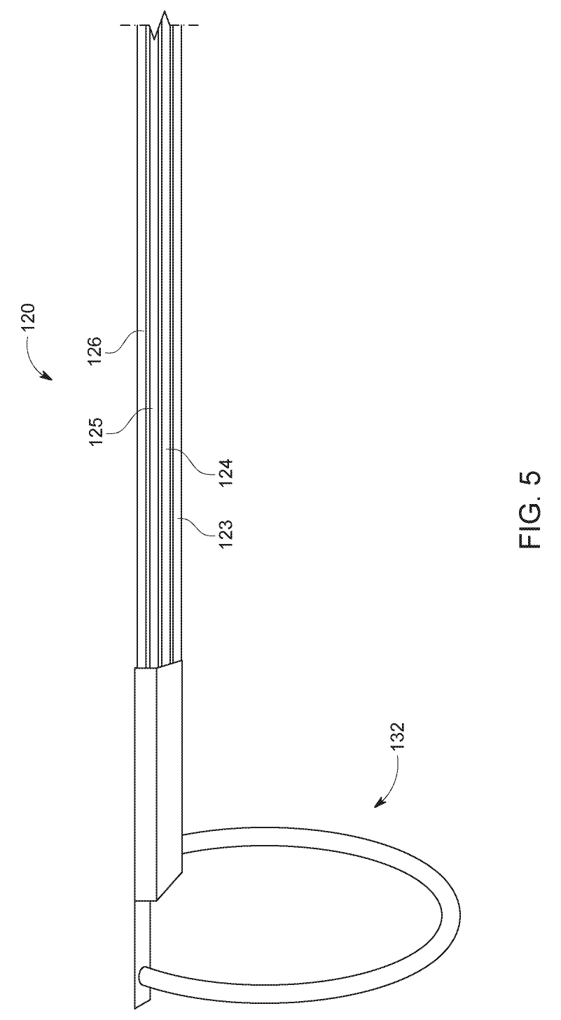

Referring to FIG. 5, a second view of the tip of the fishing rod with adjustable action is shown.

In this figure, the tip top guide 132 is affixed to the first planar element 123, second planar element 124, third planar element 125 and fourth planar element 126 of the planar elements 122 of the blank 120. This configuration will result in the stiffest action possible with this particular embodiment because all planar elements 122 are in use.

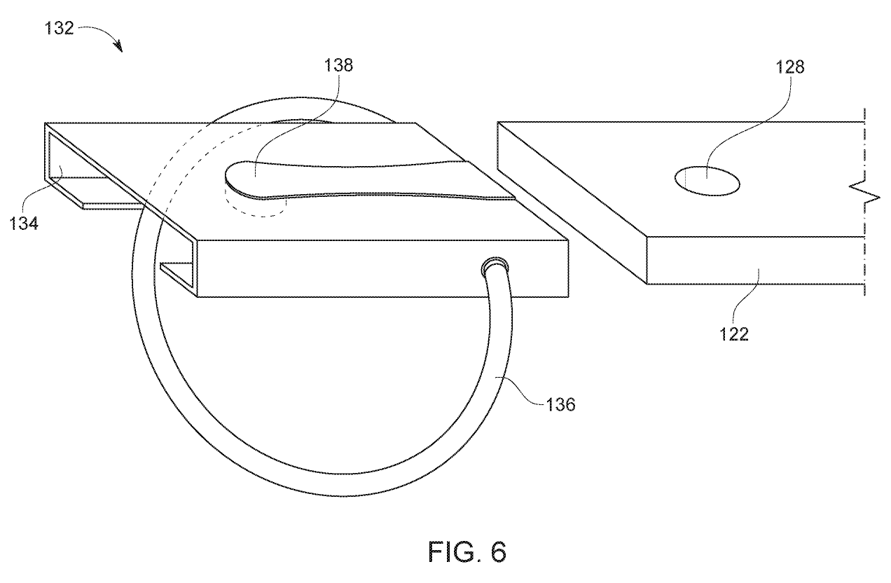

Referring to FIG. 6, a detail view of the tip top guide 132 of the fishing rod with adjustable action is shown.

The tip top guide 132 is shown with collar 134 and ring 136, the fishing line 140 passing through the ring 136.

The tip top guide 132 is also shown with locking button 138 that interfaces with the button hole 128 of any planar element 122. The result is that the tip top guide 132 is fixed in position after the number of planar elements is selected by the user.

Equivalent elements can be substituted for the ones set forth above such that they perform in substantially the same manner in substantially the same way for achieving substantially the same result.

What is claimed is:

1. A fishing rod comprising:
a handle portion;
a plurality of laminar carbon fiber elements, a first end of the plurality of laminar carbon fiber elements extending longitudinally from the handle portion, wherein each laminar carbon fiber element comprises a carbon fiber element; and
a tip top guide configured to selectively engage with a second end of one or more laminar carbon fiber elements of the plurality of laminar carbon fiber elements, the second end being distal from the first end;
wherein an action of the fishing rod is adjustable based on a number of the one or more laminar carbon fiber elements that are engaged with the tip top guide.

2. The fishing rod of claim 1, wherein each carbon fiber element of the plurality of laminar carbon fiber elements is planar.

3. The fishing rod of claim 1, wherein the plurality of laminar carbon fiber elements comprises four laminar carbon fiber elements.

4. The fishing rod of claim 1, wherein the tip top guide comprises an attachment mechanism configured to selectively secure the tip top guide to a selected number of the plurality of laminar carbon fiber elements.

5. The fishing rod of claim 1, wherein the fishing rod exhibits a first action characteristic when the tip top guide engages with one laminar carbon fiber element, and exhibits a second action characteristic when the tip top guide engages with two laminar carbon fiber elements, wherein the second action characteristic is stiffer than the first action characteristic.

6. The fishing rod of claim 5, wherein the fishing rod exhibits a third action characteristic when the tip top guide engages with three laminar carbon fiber elements, and exhibits a fourth action characteristic when the tip top guide engages with four laminar carbon fiber elements, wherein the third action characteristic is stiffer than the second action characteristic, and the fourth action characteristic is stiffer than the third action characteristic.

7. The fishing rod of claim 1, wherein the tip top guide comprises:
a ring through which a fishing line passes; and
a connecting portion configured to selectively attach to one or more of the plurality of laminar carbon fiber elements.

8. The fishing rod of claim 1, wherein the plurality of laminar carbon fiber elements are arranged in a substantially parallel configuration.

9. The fishing rod of claim 1, wherein the handle portion comprises a securing mechanism configured to secure the first end of the plurality of laminar carbon fiber elements in a predetermined orientation.

10. A fishing rod blank comprising:
a plurality of carbon fiber elements configured to extend longitudinally from a handle portion to a tip portion;
wherein the plurality of carbon fiber elements are arranged in a substantially parallel configuration; and
wherein each carbon fiber elements is configured to be selectively engaged with a tip top guide;
wherein an action characteristic of the fishing rod blank is determined by a number of carbon fiber elements engaged with the tip top guide.

11. The fishing rod blank of claim 10, wherein each carbon fiber element of the plurality of carbon fiber elements is planar.

12. A fishing rod blank comprising:
a plurality of resilient elements configured to extend longitudinally from a handle portion to a tip portion;
wherein each resilient element of the plurality of resilient elements is arranged in a substantially parallel configuration to other resilient element of the plurality of resilient elements; and
wherein each of the resilient elements is configured to be selectively engaged with a tip top guide;
wherein an action characteristic of the fishing rod blank is determined by a number of resilient elements engaged with the tip top guide.

13. The fishing rod blank of claim 12, wherein each resilient element of the plurality of resilient elements is planar.

14. The fishing rod blank of claim 12, wherein each resilient element of the plurality of resilient elements is a planar carbon fiber element.
